(19) United States
(12) Patent Application Publication
(10) Pub. No.: US 2009/0276502 A1
(43) Pub. Date: Nov. 5, 2009

(54) Network Switch with Shared Memory

(75) Inventors: Charles Kenneth Nicholas, Columbia, MD (US); Naomi Anna Avigdor, New York, NY (US); Richard Scott Cost, Baltimore, MD (US); Benjamin David Kerman, Ellicott City, MD (US); Frances Ann Roth, Cantonsville, MD (US)

Correspondence Address: Rene A. Vazquez, P.O. Box 9744, McLean, VA, 22102, US

(73) Assignee: University of Maryland, Baltimore County

(21) Appl. No.: 12/398,014

(22) Filed: Mar. 4, 2009

Related U.S. Application Data
(63) Continuation of application No. 10/840,385, filed on May 7, 2004, now abandoned.
(60) Provisional application No. 60/469,557, filed on May 9, 2003.

(51) Int. Cl. H04L 12/56

(52) U.S. Cl. 709/213

(57) ABSTRACT

A network switch that incorporates memory that can be shared by computers or processors connected to the network switch is provided. The network switch of the present invention is particularly suitable for use in a computer cluster, such as a Beowulf cluster, in which each computer in the cluster can use the shared memory resident in at least one of the network switches.

### REFERENCE TO RELATED APPLICATIONS

This application is a continuation of U.S. patent application Ser. No. 10/840,385 filed on May 7, 2004, which claims the benefit of provisional U.S. Patent Application No. 60/469,557, filed May 9, 2003.

### GOVERNMENT RIGHTS

This invention was made with government support under Grant No. MDA904-97-C-3059 awarded by the National Security Agency. The government has certain rights in this invention.

### BACKGROUND OF THE INVENTION

1. Field of the Invention

The present invention relates to network switches and, more particularly, to a network switch with memory that is adapted to be shared by computers connected to the network switch.

2. Background of the Related Art

Modern supercomputers contain a large number of processors, an amount of shared memory, and are generally very expensive. The shared memory used in supercomputers is often the most expensive type of memory available, because it needs to be as fast as possible, and also needs specialized hardware to keep the various processors from reading or writing to a portion of the memory that another processor is writing to.

Some programs are the type that are amenable to parallelization, and are thus able to benefit from execution on a multiple processor platform. However, while a program may benefit from execution on a multiple processor platform, that program may only require a small amount of shared memory.

Clusters of computers, especially clusters of commodity personal computers connected via a local area network (LAN), are becoming increasingly popular. The Beowulf architecture is a common type of computer cluster, although other forms of computer clusters are available. Such computer clusters, by virtue of the commodity hardware that is used to build them, offer significant cost and reliability advantages over traditional supercomputers. However, it is impractical for computers in a cluster to share physical memory in the same manner as processors in supercomputers do. This limits the effective use of such computer clusters to applications in which the need for fast access to shared memory is not as important as other factors

### SUMMARY OF THE INVENTION

An object of the invention is to solve at least the above problems and/or disadvantages and to provide at least the advantages described hereinafter.

Therefore, an object of the present invention is to provide a network switch that incorporates memory that can be shared by computers or processors connected to the network switch.

Another object of the present invention is to provide a network that utilizes at least one network switch that contains memory that can be shared by computers or processors in the network.

To achieve at least the above objects, in whole or in part, there is provided a network switch, including a processor, at least one communication port and a memory, wherein at least a first portion of the memory is shared memory that is adapted to be shared by at least two computers connected to the network.

To achieve at least the above objects, in whole or in part, there is further provided a network, including at least one network switch, wherein the at least one network switch includes a processor, at least one communication port and a memory, wherein at least a first portion of the memory is shared memory that is adapted to be shared by at least two computers connected to the network switch, and at least two computers connected to at least one of the network switches.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic diagram of a typical local area network (LAN), in which multiple computers are connected via a network switch;

FIG. 2 is a schematic diagram showing multiple computers connected via a network switch with shared memory, in accordance with one embodiment of the present invention;

FIG. 3 is a schematic diagram showing multiple computers connected via a network switch with dynamic shared memory, in accordance with another embodiment of the present invention;

FIG. 4 is a schematic diagram showing multiple computers connected via a network switch with RAM disk shared memory, in accordance with another embodiment of the present invention

FIG. 5 is a schematic diagram of one preferred embodiment of the network switch with shared memory of FIGS. 2-4; and

FIG. 6 is a schematic diagram of a computer cluster utilizing the network switch with shared memory, in accordance with one embodiment of the present invention.

### DETAILED DESCRIPTION OF PREFERRED EMBODIMENTS

Multiple computers are commonly linked together using a local area network (LAN). A network switch is a key component of many LANs, and its purpose is to receive packets of data from one computer and pass it on to another computer, based on the information contained in each packet.

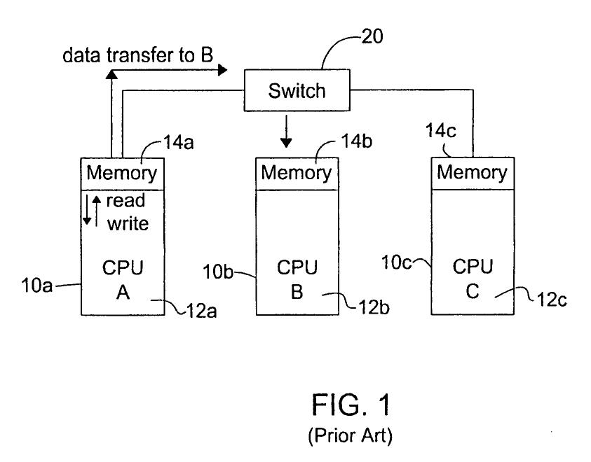

FIG. 1 is a schematic diagram of a typical LAN. The LAN is made up of a plurality of computers 10a-10c and a network switch 20. Each computer constitutes a “node” in the LAN and is made up of a CPU 12a-12c and a local memory 14a-14c.

As shown in FIG. 1, the computers 10a-10c connected by such a network switch 20 are typically physically autonomous, and may be separated by some physical distance. The computers 10a-10c have their own respective processor memory 14a-14c, and do not share each other's processor memory.

Data is transferred from the memory of one computer to the memory of a second computer through the network switch 20. Messages are passed through standard protocols such as, for example, TCP and UDP. The network switch 20 generally contains memory (not shown) that is used to move the data packets from one node in the LAN to another. Such data packets spend a certain amount of time in the memory of the network switch 20 as it is received from one node, and are then transmitted to another node.

A LAN can be used to create a computer cluster, such as a Beowulf computer cluster. Such computer clusters may have the same amount of processing power as a supercomputer when measured in terms of total operations per second. However, such computer clusters typically have no shared memory. Instead, processes executing on the various computers in the cluster communicate with each other via a network switch and standard protocols (e.g., TCP or UDP), and perhaps with the help of software that implements, for example, the Message Passing Interface (MPI).

Communication costs must be considered when estimating the total cost of a computation. In many cases, the communication costs dominate and are far greater than the cost of CPU time or I/O. It is generally desirable to keep the communication portion of the total cost of computation down to a minimum, if reasonable performance is desired. Thus, considerable effort may be needed to adapt an algorithm so that it runs effectively on a computer cluster.

A problem's “granularity” refers to the ease with which a problem can be divided into smaller sub-problems that are suited for running on a computer cluster. The granularity of a problem is also related to the extent to which the sub-problems need to share data.

In a typical computer cluster, such data sharing between sub-problems may take place in several ways. Computer clusters often have shared file systems, which allow processors to read and write information to disk. Clusters may also employ some form of message passing, which is one way to implement a form of shared memory.

In a distributed shared memory, one or more nodes in the network may be designated as memory nodes. These memory nodes provide some memory that can be shared among all the nodes in the network. Whenever access to shared data is desired, a message is sent from the requesting node to the memory node where the information resides, and the data is sent back in a separate message. This is a software-only solution that requires no extra hardware, but it may be too slow for satisfactory performance, especially if communication to and from the memory nodes becomes bottlenecked.

If the amount of data to be shared is small, then this approach may be acceptable. However, as the amount of data grows, issues such as disk latency and file system contention become significant.

Some algorithms are well suited to an environment with no shared memory, while others require large amounts of shared memory. However, there is an increasing class of algorithms that fall between these two extremes, in that these algorithms can run faster as a result of having a relatively small amount of shared memory.

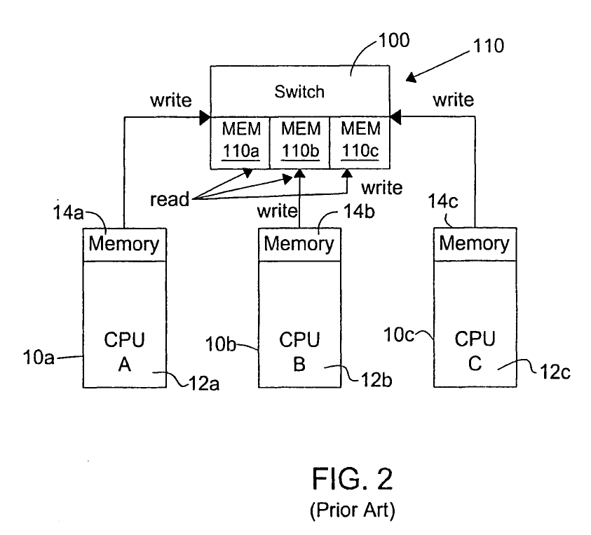

In the network switch of the present invention, a portion of the network switch memory is configured to be “shared memory” that can be shared by every node in a LAN or computer cluster. FIG. 2 is a schematic diagram of a LAN that utilizes the network switch with shared memory of the present invention. The LAN includes a plurality of computers (nodes) 10a-10c, with respective CPU's 12a-12c and local memories 14a-14c. The network switch 100 contains shared memory 110 that is preferably partitioned into a plurality of shared memory portions 110a-110c. The shared memory 110 is preferably partitioned so that each computer is assigned one portion of the shared memory 110.

In the example shown in FIG. 2, computer 10a is assigned shared memory portion 110a, computer 10b is assigned shared memory portion 110b and computer 10c is assigned shared memory portion 110c. Each computer may read each others shared memory portion at any time, including in parallel, as long as the shared memory portion is not being written to. For example, if computer 10a is to send the same data to both computers 10b and 10c, computer 10a will store the data in its writable shared memory portion 110a. Computer 10a will then send short messages to computers 10b and 10c, by standard protocols, indicating where the data is to be found and that it is ready to be accessed. Computers 10b and 10c can then access the data as they need it, simultaneously if need be, without further assistance of computer 10a. When computers 10b and 10c have the data, they notify computer 10a and computer 10a is then free to write new data onto its shared memory portion 110a.

In the example of FIG. 2, a fixed amount of shared memory is allocated to each node. However, in some applications a fixed amount of memory for each node may not result in the most efficient use of shared memory, since different nodes may require different amounts at different times, and one node many run short of memory while another node has more memory than it needs.

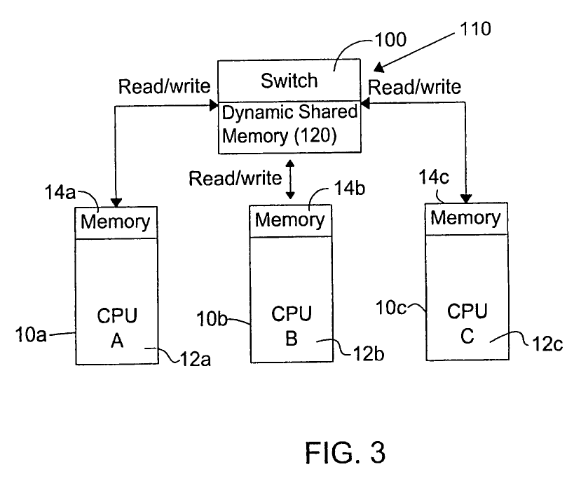

Accordingly, as shown in FIG. 3, a shared memory 110 may be implemented as dynamic shared memory 120 which is allocated in a dynamic fashion, with nodes acquiring and releasing portions of the shared memory. The network switch 100 with dynamically shared memory 120 preferably includes software known in the art for keeping track of which regions of shared memory are allocated to particular processes, and access for reading and writing is controlled accordingly. The dynamic shared memory 120 operates in manner that is similar to dynamically allocated virtual memory in ordinary operating systems, such as described in John L. Hennessy and David A. Patterson, Computer Architecture A Quantitative Approach, 3^{rd} ed., Morgan Kaufmann (2003), which is hereby incorporated by reference in its entirety.

The dynamically shared memory 120 represents a pool of shared memory. In a preferred embodiment, a shared memory protocol is used with the dynamically shared memory 120 that provides the following operations:

(1) “Initialize”: prepare the network switch 100 to accept other commands;

(2) “Allocate”: assign a region of shared memory 110 to a specific process or set of processes;

(3) “Free”: release an allocated region of shared memory;

(4) “Write”: store information in allocated memory;

(5) “Read”: access previously written information;

(6) “Lock”: prevent other processes from reading or writing to a specific location or region of memory;

(7) “Unlock”: allow other processes to resume reading and writing memory;

(8) “Update”: lock, write and unlock in a single step; and

(9) “Status”: report on the amount of shared memory in use.

The operations listed above may involve the creation and manipulation of switch addresses, which refer to locations or regions of shared memory, in a fashion that identifies the memory as shared memory 110, rather than ordinary node processor memory. The network switch 100 of the present invention extends the functionality of previous network switches, which would only receive incoming packets, determine where they need to go, and transmit them accordingly. The network switch 100 of the present invention is adaptive, such that when a message addressed to the network switch 100 is received, the message is inspected to determine if it contains a shared memory protocol message, such as the ones listed above. If a shared memory protocol message is received, then the network switch 100 acts on the message by performing the indicated operation. Alternatively, the shared memory protocol messages could be directed to a predetermined network address at the network switch 100, in which case all messages directed to the predetermined network address are presumed to be shared memory protocol messages.

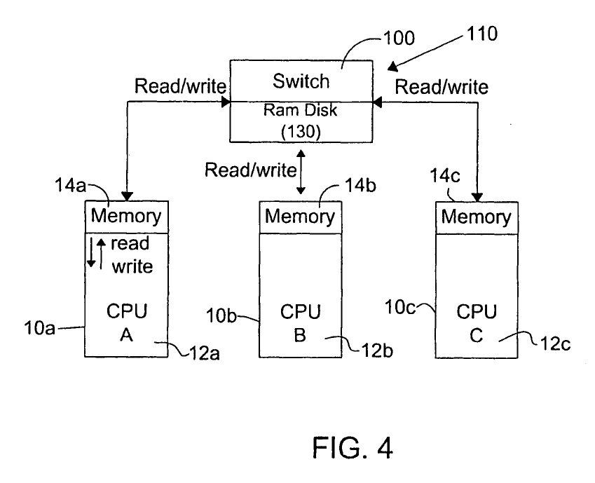

The shared memory 110 can also be implement as a random access memory (RAM) disk 130, as shown in FIG. 4. A RAM disk 130 can be thought of as a large segment of memory where files can be created, read and written as an ordinary disk, but without using a physical disk. In the embodiment of FIG. 4, a RAM disk 130 is created and file system support is provided so that the various computers 10a-10c in the LAN can mount the RAM disk remotely. In this embodiment, each of the computers 10a-10c can create, read and write files, as they would with an ordinary shared hard disk, under a network file-sharing protocol, such as NFS. Alternatively, a protocol of the type used for storage area networks (SANs) may be used.

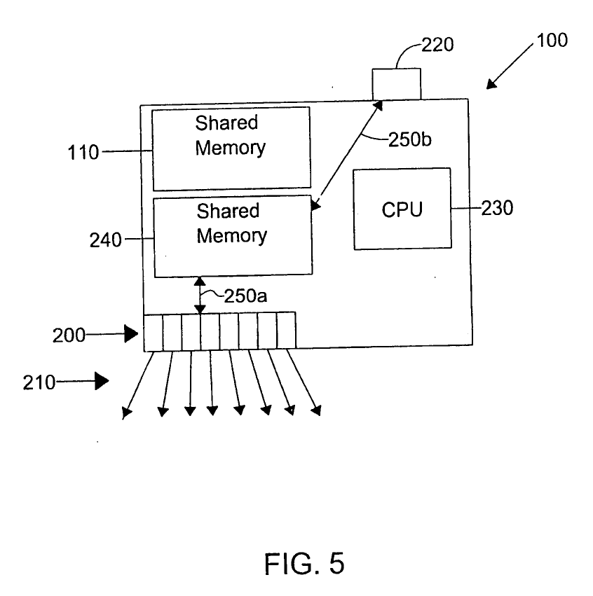

FIG. 5 is a schematic diagram of one preferred embodiment of the network switch 100 of the present invention. The network switch 100 includes a set of ports 200 that are used to communicate with a plurality of computers or nodes via respective communication channels 210. The network switch 100 may optionally include an additional port 220 (or ports), possibly running at higher speed, and also known as “uplink ports” for connecting outside the LAN, e.g., to the Internet. In the example of FIG. 4, the network switch 100 contains eight ordinary ports 210 and one uplink port 220.

The network switch 100 contains a CPU 230, which runs a driver that consists of software, possibly assisted by firmware, designed to manage the movement of data packets from one port to another, perform diagnostics and manage the network switch's own memory. The network switch's memory is divided logically, and optionally physically, into two sections. One portion of memory 240 is used to store packets as they are routed from one port to another. The other portion is the shared memory 110, which is available for use by the various computers or nodes in the network. Connections 250a and 250b between the ports 210 and the memories 110 and 240, as well as between the port 220 and the memories 110 and 240, are of such capacity as needed to allow for the movement of packets from port to port, as well as the extra packets moving in and out of the shared memory 110.

Operation of the network switch 100 of the present invention will now be illustrated with reference to FIG. 2. In the example of FIG. 2, three computers 10a-10c are shown. The shared memory 110 is partitioned into shared memory portions 110a-110c so that each computer 10a-10c is assigned respective shared memory portion. The computers 10a-10c may read each other's shared memory portions at any time, even in parallel, as long as the shared memory portion being read is not being written upon.

For example, if computer 10a needs to send data to computers 10b and 10c, computer 10a will store the data in its writable shared memory portion 110a on the network switch 100. Computer 10a will then send short messages to computers 10b and 10c, by standard protocols, indicating where the data is located, and that it is ready to be read. Computers 10b and 10c can then access the data as needed, even simultaneously, without further assistance from computer 10a. When computers 10b and 10c have the data, they notify computer 10a and computer 10a is then free to write new data or reuse its shared memory portion 110a.

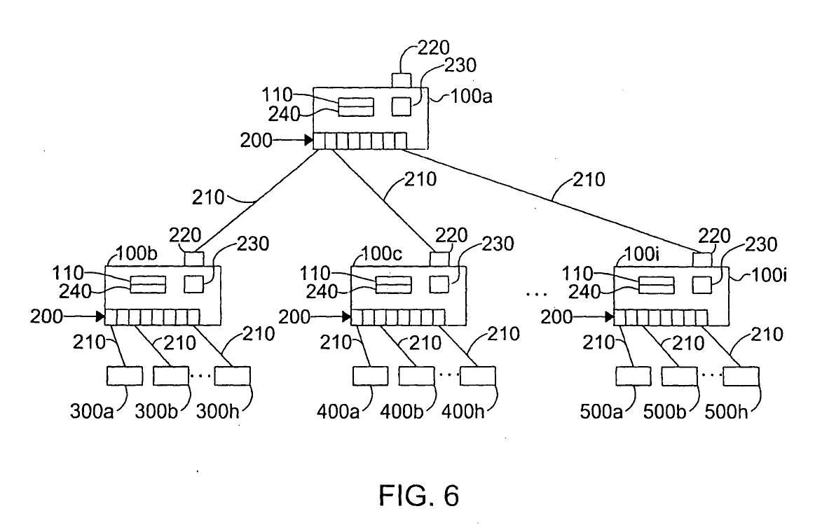

As discussed above, the network switch 100 of the present invention is particularly suitable for use in computer clusters in which some amount of shared memory is desirable. FIG. 6 is a schematic diagram illustrating how a computer cluster can utilize the network switch 100 of the present invention. The computer cluster shown in FIG. 6 is made up of 64 computers that are grouped in eight sets of eight computers. Each set of eight computers is connected to a single network switch. For purposes of illustration, only a subset of the 64 computers and a subset of the respective network switches are shown in FIG. 6. Specifically, computers 300a, 300b and 300h are shown connected to the first second and eighth ports, respectively, of network switch 100b. Similarly, computers 400a, 400b and 400h are shown connected to the first, second and eighth ports of network switch 100c, and computers 500a, 500b and 500h are shown connected to the first, second and eighth ports of network switch 100i. Although not explicitly shown, it should be appreciated that there are five additional network switches for connecting five more sets of eight computers, and that there are five additional computers connected to ports 3-7 of each network switch. Each network switch 100b-100i is connected via their respective uplink ports 220 to the ports 200 of another network switch 100a.

As discussed above, the shared memory 240 of each network switch 100a-100i can be configured so that there are fixed shared memory portions allocated to each computer connected to the switch. Alternatively, as discussed above, the shared memory 240 in any one or more of the network switches 100a-100i can be set up as a RAM disk, and file system support would then be provided so that the various nodes in the cluster can mount the RAM disk remotely.

A network switch utilizing a RAM disk would incorporate software that uses appropriate protocols, such as the protocols discussed above, to allocate a region of shared memory of sufficient size to accommodate a desired disk image. The software is preferably configured to cause the network switch resident RAM disk to be mounted as a file system on each node wishing to have access. Each node will then be able to create, read and write files, as they would with an ordinary shared hard disk, doing so under a network file-sharing protocol, such as NFS or a protocol of the sort used for SANs. The network switch-resident RAM disk would then be available for use by each node in the cluster, but no physical disk drive would be needed. Files can be created and used on the RAM disk, and conventional file locking techniques can be used to keep the data consistent.

A program designed for use on a supercomputer with tightly coupled processors can be run on a loosely coupled cluster of computers, such as the computer cluster shown in FIG. 5, in which the computers are connected via one or more of the network switches of the present invention. As an example, assume that the program in question complies with OpenMP which is a protocol that provides a shared memory abstraction. As the program begins execution, some number of processes are spawned and begin execution on the various nodes 300a-500h. When a variable or other data structure is declared as “shared”, appropriate software is invoked to allocate the variable or data structure in physical shared memory. Such software is usually packaged in an OpenMP library. In a physical memory environment, e.g., a traditional supercomputer, the software simply allocates the necessary shared memory and returns a response to the calling program. For example, if an allocation of shared memory is requested, a pointer to the memory is returned to the caller.

With the network switch of the present invention, an OpenMP library need only be modified to use the shared memory protocols of the present invention to allocate and manipulate shared memory. For example, if a region of shared memory is requested by the calling program, the OpenMP library would not allocate the memory itself, but would instead preferably send an appropriate message using the shared memory protocols of the present invention. Reading, writing and freeing of memory would be accomplished in a similar fashion.

The CPUs 230, the network switches 100, as well as the computers or nodes that are connected to the network switches 100 can be general purpose computers. However, they can also be special purpose computers, programmed microprocessors or microcontrollers and peripheral integrated circuit elements, ASICs or other integrated circuits, hardwired electronic or logic circuits such as discrete element circuits, programmable logic devices such as FPGA, PLD, PLA or PAL or the like. In general, any device on which a finite state machine capable of executing code can be used to implement the CPUs 230 and computers of the present invention.

Communications channels 210 may be, include or interface to any one or more of, for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34bis analog modem connection, a cable modem, and ATM (Asynchronous Transfer Mode) connection, or an FDDI (Fiber Distributed Data Interface) or CDDI (Copper Distributed Data Interface) connection. Communications channel 210 may furthermore be, include or interface to any one or more of a WAP (Wireless Application Protocol) link, a GPRS (General Packet Radio Service) link, a GSM (Global System for Mobile Communication) link, CDMA (Code Division Multiple Access) or TDMA (Time Division Multiple Access) link such as a cellular phone channel, a GPS (Global Positioning System) link, CDPD (Cellular Digital Packet Data), a RIM (Research in Motion, Limited) duplex paging type device, a Bluetooth radio link, or an IEEE 802.11-based radio frequency link. Communications channels 210 may yet further be, include or interface to any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired or wireless, digital or analog interface or connection.

As discussed above, the shared memory 110 can be implemented with a hard drive, dynamic shared memory or RAM. However, the shared memory 110 can be implemented with any other type of electronic memory or storage device using any type of media, such as magnetic, optical or other media.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Various changes may be made without departing from the spirit and scope of the invention, as defined in the following claims.

What is claimed is:

1. A network switch, comprising:
a processor;
at least one communication port; and
a memory having at least a first portion that comprises shared memory that is adapted accessible by at least two computers connected to the network switch, wherein the shared memory is configured such that the at least two computers connected to the network can write data to the shared memory and read data, serially or in parallel, from the shared memory by sending shared memory protocol messages to the processor.

2. The network switch of claim 1, wherein the shared memory comprises a hard drive.

3. The network switch of claim 2, wherein the shared memory is partitioned so that each of the at least two computers is allocated a respective sub portion of the shared memory for writing data.

4. The network switch of claim 1, wherein the shared memory comprises random access memory (RAM).

5. The network switch of claim 1, wherein the shared memory comprises dynamic shared memory.

6. The network switch of claim 1, wherein the memory comprises a second portion for transmission of data between the at least two computers.

7. The network switch of claim 1, wherein the processor is programmed with protocols for managing the shared memory and transmission of data.

8. The network switch of claim 5, wherein the processor is programmed with protocols for managing the dynamic shared memory.

9. The network switch of claim 8, wherein the protocols are adapted to prevent simultaneous reading and writing of a common portion of the shared memory.

10. The network switch of claim 8, wherein the protocols are adapted to assign a portion of shared memory to a specific process or set of processes.

11. The network switch of claim 7, wherein the protocols are adapted to support a hierarchy of network switches connected to a common network.

12. A network, comprising:
at least one network switch, wherein at least one of the network switches comprises,
a processor,
at least one communication port, and
a memory having at least a first portion that comprises shared memory that is adapted accessible by at least two computers connected to the network switch, wherein the shared memory is configured such that the at least two computers connected to the network can write data to the shared memory and read data, serially or in parallel, from the shared memory by sending shared memory protocol messages to the processor; and
at least two computers connected to at least one of the network switches.

13. The network of claim 12, wherein the shared memory comprises a hard drive.

14. The network of claim 13, wherein the shared memory is partitioned so that each of the at least two computers is allocated a respective sub portion of the shared memory for writing data.

15. The network of claim 12, wherein the shared memory comprises random access memory (RAM).

16. The network of claim 12, wherein the shared memory comprises dynamic shared memory.

17. The network of claim 12, wherein the memory comprises a second portion for transmission of data between the at least two computers.

18. The network of claim 12, wherein the processor is programmed with protocols for managing the shared memory and transmission of data.

19. The network of claim 16, wherein the processor is programmed with protocols for managing the dynamic shared memory.

20. The network of claim 19, wherein the protocols are adapted to prevent simultaneous reading and writing of a common portion of the shared memory.

21. The network of claim 19, wherein the protocols are adapted to assign a portion of shared memory to a specific process or set of processes.

22. The network of claim 18, wherein the protocols are adapted to support a hierarchy of network switches connected to a common network.

23. The network of claim 22, wherein the protocols are adapted so that data to be shared by at least two computers reside at a network switch lowest in the hierarchy and to which the at least two computers are connected.

24. A cluster computer system comprising the network of claim 12.
